(19) United States
(12) Patent Application Publication
(10) Pub. No.: US 2009/0136042 A1
(43) Pub. Date: May 28, 2009

(54) APPLICATION LAYER AUTHORIZATION TOKEN AND METHOD

(76) Inventor: Michel VEILLETTE, Waterloo (CA)

Correspondence Address: King and Spalding LLP (Trilliant);Trilliant Customer Number, 1700 Pennsylvania Avenue, NW, Suite 200, Washington, DC, 20006, US

(21) Appl. No.: 12/275,275

(22) Filed: Nov. 21, 2008

Related U.S. Application Data
(60) Provisional application No. 60/989,957, filed on Nov. 25, 2007.
(60) Provisional application No. 60/989,967, filed on Nov. 25, 2007.
(60) Provisional application No. 60/989,958, filed on Nov. 25, 2007.
(60) Provisional application No. 60/989,964, filed on Nov. 25, 2007.
(60) Provisional application No. 60/989,950, filed on Nov. 25, 2007.
(60) Provisional application No. 60/989,950, filed on Nov. 25, 2007.
(60) Provisional application No. 60/989,953, filed on Nov. 25, 2007.
(60) Provisional application No. 60/989,975, filed on Nov. 25, 2007.
(60) Provisional application No. 60/989,959, filed on Nov. 25, 2007.
(60) Provisional application No. 60/989,961, filed on Nov. 25, 2007.
(60) Provisional application No. 60/989,962, filed on Nov. 25, 2007.
(60) Provisional application No. 60/989,951, filed on Nov. 25, 2007.
(60) Provisional application No. 60/989,955, filed on Nov. 25, 2007.
(60) Provisional application No. 60/989,952, filed on Nov. 25, 2007.
(60) Provisional application No. 60/989,954, filed on Nov. 25, 2007.
(60) Provisional application No. 60/992,317, filed on Dec. 4, 2007.
(60) Provisional application No. 60/992,312, filed on Dec. 4, 2007.
(60) Provisional application No. 60/992,313, filed on Dec. 4, 2007.
(60) Provisional application No. 60/992,315, filed on Dec. 4, 2007.
(60) Provisional application No. 61/025,279, filed on Jan. 31, 2008.
(60) Provisional application No. 61/025,270, filed on Jan. 31, 2008.
(60) Provisional application No. 61/025,276, filed on Jan. 31, 2008.
(60) Provisional application No. 61/025,282, filed on Jan. 31, 2008.
(60) Provisional application No. 61/025,271, filed on Jan. 31, 2008.
(60) Provisional application No. 61/025,287, filed on Jan. 31, 2008.
(60) Provisional application No. 61/025,278, filed on Jan. 31, 2008.
(60) Provisional application No. 61/025,273, filed on Jan. 31, 2008.
(60) Provisional application No. 61/025,277, filed on Jan. 31, 2008.
(60) Provisional application No. 61/025,654, filed on Feb. 1, 2008.
(60) Provisional application No. 61/094,116, filed on Sep. 4, 2008.

(51) Int. Cl. H04L 9/00

(52) U.S. Cl. 380/279

(57) ABSTRACT

An authorization token may provide security for operations. The authorization token may be encrypted by a key manager of a head end system so that only a target device may decrypt the authorization token and perform an operation.

### CROSS-REFERENCE TO RELATED APPLICATIONS

This application claims the benefit of priority to the following United States provisional patent applications which are incorporated herein by reference in their entirety:
Ser. No. 60/989,957 entitled “Point-to-Point Communication within a Mesh Network”, filed Nov. 25, 2007 (Attorney Docket No. TR0004-PRO);
Ser. No. 60/989,967 entitled “Efficient And Compact Transport Layer And Model For An Advanced Metering Infrastructure (AMI) Network,” filed Nov. 25, 2007 (Attorney Docket No. TR0003-PRO);
Ser. No. 60/989,958 entitled “Creating And Managing A Mesh Network Including Network Association,” filed Nov. 25, 2007 (Attorney Docket No. TR0005-PRO);
Ser. No. 60/989,964 entitled “Route Optimization Within A Mesh Network,” filed Nov. 25, 2007 (Attorney Docket No. TR0007-PRO);
Ser. No. 60/989,950 entitled “Application Layer Device Agnostic Collector Utilizing ANSI C12.22,” filed Nov. 25, 2007 (Attorney Docket No. TR0009-PRO);
Ser. No. 60/989,953 entitled “System And Method For Real Time Event Report Generation Between Nodes And Head End Server In A Meter Reading Network Including From Smart And Dumb Meters,” filed Nov. 25, 2007 (Attorney Docket No. TR0010-PRO);
Ser. No. 60/989,975 entitled “System and Method for Network (Mesh) Layer And Application Layer Architecture And Processes,” filed Nov. 25, 2007 (Attorney Docket No. TR0014-PRO);
Ser. No. 60/989,959 entitled “Tree Routing Within a Mesh Network,” filed Nov. 25, 2007 (Attorney Docket No. TR0017-PRO);
Ser. No. 60/989,961 entitled “Source Routing Within a Mesh Network,” filed Nov. 25, 2007 (Attorney Docket No. TR0019-PRO);
Ser. No. 60/989,962 entitled “Creating and Managing a Mesh Network,” filed Nov. 25, 2007 (Attorney Docket No. TR0020-PRO);
Ser. No. 60/989,951 entitled “Network Node And Collector Architecture For Communicating Data And Method Of Communications,” filed Nov. 25, 2007 (Attorney Docket No. TR0021-PRO);
Ser. No. 60/989,955 entitled “System And Method For Recovering From Head End Data Loss And Data Collector Failure In An Automated Meter Reading Infrastructure,” filed Nov. 25, 2007 (Attorney Docket No. TR0022-PRO);
Ser. No. 60/989,952 entitled “System And Method For Assigning Checkpoints To A Plurality Of Network Nodes In Communication With A Device Agnostic Data Collector,” filed Nov. 25, 2007 (Attorney Docket No. TR0023-PRO);
Ser. No. 60/989,954 entitled “System And Method For Synchronizing Data In An Automated Meter Reading Infrastructure,” filed Nov. 25, 2007 (Attorney Docket No. TR0024-PRO);
Ser. No. 60/992,317 entitled “Application Layer Authorization Token and Method” filed on Dec. 4, 2007 (Attorney Docket No. TR0025-PRO);
Ser. No. 60/992,312 entitled “Mesh Network Broadcast,” filed Dec. 4, 2007 (Attorney Docket No. TR0027-PRO);
Ser. No. 60/992,313 entitled “Multi Tree Mesh Networks”, filed Dec. 4, 2007 (Attorney Docket No. TR0028-PRO);
Ser. No. 60/992,315 entitled “Mesh Routing Within a Mesh Network,” filed Dec. 4, 2007 (Attorney Docket No. TR0029-PRO);
Ser. No. 61/025,279 entitled “Point-to-Point Communication within a Mesh Network”, filed Jan. 31, 2008 (Attorney Docket No. TR0030-PRO), and which are incorporated by reference.
Ser. No. 61/025,270 entitled “Application Layer Device Agnostic Collector Utilizing Standardized Utility Metering Protocol Such As ANSI C12.22,” filed Jan. 31, 2008 (Attorney Docket No. TR0031-PRO);
Ser. No. 61/025,276 entitled “System And Method For Real-Time Event Report Generation Between Nodes And Head End Server In A Meter Reading Network Including Form Smart And Dumb Meters,” filed Jan. 31, 2008 (Attorney Docket No. TR0032-PRO);
Ser. No. 61/025,282 entitled “Method And System for Creating And Managing Association And Balancing Of A Mesh Device In A Mesh Network,” filed Jan. 31, 2008 (Attorney Docket No. TR0035-PRO);
Ser. No. 61/025,271 entitled “Method And System for Creating And Managing Association And Balancing Of A Mesh Device In A Mesh Network,” filed Jan. 31, 2008 (Attorney Docket No. TR0037-PRO);
Ser. No. 61/025,287 entitled “System And Method For Operating Mesh Devices In Multi-Tree Overlapping Mesh Networks”, filed Jan. 31, 2008 (Attorney Docket No. TR0038-PRO);
Ser. No. 61/025,278 entitled “System And Method For Recovering From Head End Data Loss And Data Collector Failure In An Automated Meter Reading Infrastructure,” filed Jan. 31, 2008 (Attorney Docket No. TR0039-PRO);
Ser. No. 61/025,273 entitled “System And Method For Assigning Checkpoints to A Plurality Of Network Nodes In Communication With A Device-Agnostic Data Collector,” filed Jan. 31, 2008 (Attorney Docket No. TR0040-PRO);
Ser. No. 61/025,277 entitled “System And Method For Synchronizing Data In An Automated Meter Reading Infrastructure,” filed Jan. 31, 2008 (Attorney Docket No. TR0041-PRO);
Ser. No. 61/025,654 entitled “Application Layer Authorization Token And Method” filed Feb. 1, 2008 (TR0043-PRO);
Ser. No. 61/094,116 entitled “Message Formats and Processes for Communication Across a Mesh Network,” filed Sep. 4, 2008 (Attorney Docket No. TR0049-PRO).

This application hereby references and incorporates by reference each of the following United States nonprovisional patent applications filed contemporaneously herewith:
Ser. No. ______ entitled “Point-to-Point Communication within a Mesh Network”, filed Nov. 21, 2008 (Attorney Docket No. TR0004-US);
Ser. No. ______ entitled “Efficient And Compact Transport Layer And Model For An Advanced Metering Infrastructure (AMI) Network,” filed Nov. 21, 2008 (Attorney Docket No. TR0003-US);
Ser. No. ______ entitled “Communication and Message Route Optimization and Messaging in a Mesh Network,” filed Nov. 21, 2008 (Attorney Docket No. TR0007-US);
Ser. No. ______ entitled “Collector Device and System Utilizing Standardized Utility Metering Protocol,” filed Nov. 21, 2008 (Attorney Docket No. TR0009-US);
Ser. No. ______ entitled “Method and System for Creating and Managing Association and Balancing of a Mesh Device in a Mesh Network,” filed Nov. 21, 2008 (Attorney Docket No. TR0020-US); and
Ser. No. ______ entitled “System And Method For Operating Mesh Devices In Multi-Tree Overlapping Mesh Networks”, filed Nov. 21, 2008 (Attorney Docket No. TR0038-US).

### FIELD OF THE INVENTION

This invention pertains to systems, devices, and methods for providing a security authorization mechanism that allows activities to take place respective of a device, such as for example Advanced Metering Infrastructure device software and/or firmware changes or upgrades, while preventing malicious activity such as hacking or tampering.

### BACKGROUND

Devices may at times require software or firmware upgrades, instructions, or other operations. In a non-secure environment, such devices may be hacked or otherwise tampered with by a user or other human or non-human entity. Such hacking may be by sending operations and/or commands to the device or otherwise communicating with the device against the wishes of the party responsible for the device. Such unauthorized operations or communications may cause the device to malfunction, to function in an unintended manner, or perhaps to continue to function while providing incorrect information. Further, by accident, it may be that a device receives an operation or instruction that is intended for another device or is otherwise not suitable for the device that received it. Such an operation, if executed, could unintentionally cause the device to malfunction or to provide incorrect information or to provide information or data to a destination that should not receive such information or data.

There is therefore a need for an authorization means and mechanism, such as an authorization token at the application layer, which provides security for operations. There is also a need for a system and method of using an authorization means and mechanism, such as the authorization token, for providing an operation to a device to prevent hacking or tampering by an individual or a non-human entity.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above described problems have been reduced or eliminated, while other embodiments are directed to other improvements.

A technique provides security for an operation transmitted to a device. An operation, by way of example and not limitation, may be a firmware upgrade, a configuration command, or any transmission or communication for which security is desired. An authorization token associated with the operation and the device may be created. The authorization token may be encrypted for security to allow only the intended device to execute the operation. Various methods associated with technique may be implemented using a variety of data structures embodied in one or more computer readable media.

A system based on the technique may include an operation provider and a key manger working to provide the operation to a target device. The key manager provides an authorization token to the operation provider, which in turn provides the operation to be executed along with the authorization token to a target device. The target device may then perform the operation.

In one non-limiting aspect, there may be provided a system comprising: a key repository for storing a key; a key manager coupled to the key repository including a key generator for creating an authorization token using the key from the key repository; and an operation provider in communication with the key manager which requests the authorization token from the key manager to provide security for an operation.

In another non-limiting aspect, there may be provided a device comprising: a nonvolatile storage for storing a key; a radio receiving an authorization token and an operation; and a logic unit coupled to the nonvolatile storage unit and the radio, wherein the logic unit receives the authorization token and the operation, decrypts the authorization token using the key, verifies the operation, and performs the operation.

In another non-limiting aspect, there may be provided a method comprising: receiving a request for an authorization token specifying a target device; retrieving a key associated with the target device; generating a single use authorization token associated with an upgrade for the target device; and providing the authorization token along with the upgrade to the target device.

In another non-limiting aspect, there may be provided a method comprising: receiving an operational data; receiving a key associated with a target device; encrypting the allowed operation using the key associated with the target devices as an authorization token; and providing the authorization token.

In another non-limiting aspect, there may be provided a data structure embodied in a computer readable medium comprising: transaction-allowed identifier specifying a permitted action associated with an operation and a target device; and a signature validating the operation for the target device using a key of the target device.

In another non-limiting aspect, there may be provided a computer program stored in a computer readable form for execution in a processor and a processor coupled memory to implement a method comprising: receiving a request for an authorization token specifying a target device; retrieving a key associated with the target device; generating a single use authorization token associated with an upgrade for the target device; and providing the authorization token along with the upgrade to the target device.

In another non-limiting aspect, there may be provided a computer program stored in a computer readable form for execution in a processor and a processor coupled memory to implement a method comprising: receiving an operational data; receiving a key associated with a target device; encrypting the allowed operation using the key associated with the target devices as an authorization token; and providing the authorization token.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 depicts an exemplary system for providing and using an authorization token.

FIG. 2 depicts an exemplary system for providing an authorization token.

FIG. 3 depicts a flowchart of an exemplary method for providing an authorization token.

FIG. 4 depicts an exemplary system including device keys entered into a key database.

FIG. 5 depicts aspects of an exemplary method for operation provider providing an operation to a target device using an authorization token.

FIG. 6 depicts a diagram of an exemplary encryption module creating an authorization token.

FIG. 7 depicts a flowchart of an exemplary method for creating an authorization token.

FIG. 8 depicts operation related data which may be used to implement an authorization token.

FIG. 9 depicts a diagram of an exemplary system including a remote tool using an authorization token to provide an operation to a remote target device having intermittent network communication.

FIG. 10 depicts an exemplary configuration having a plurality of devices on an automated metering infrastructure (AMI) network.

FIG. 11 depicts an exemplary target device.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

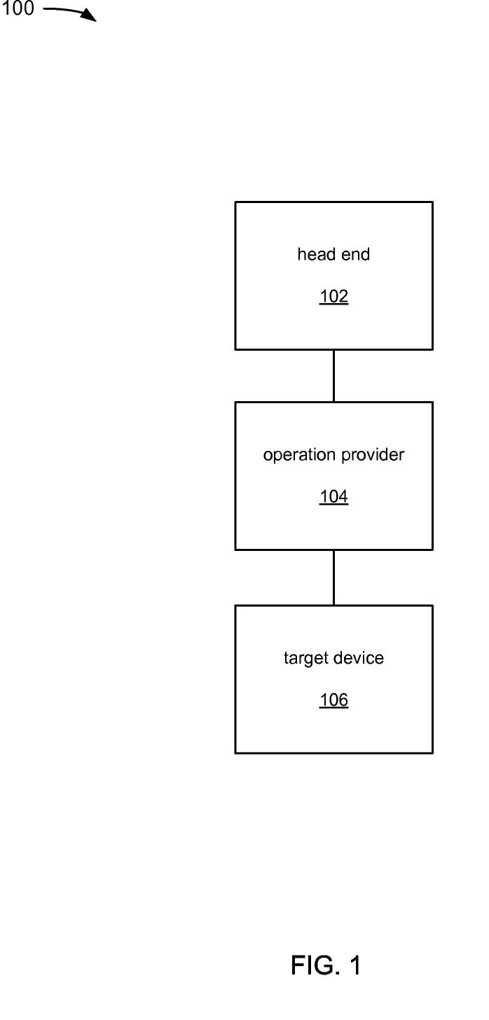

FIG. 1 depicts an exemplary system 100 for providing and using an authorization token. FIG. 1 includes head end 102, authorization token 104, and target device 106.

The head end 102 may be a system having control over the target device 106 and the operation provider 104. The head end 102 may also be referred to as back office or back end where convenient. Such head end back office, or backend may be, by way of example and not limitation, implemented as a server. The head end 102 may have a communications module for communications over a wired or wireless network. Local communications may be enabled at the head end 102 such as for receiving a tool for use in an area with intermittent network service or no network service.

As used herein, “providing” may include but is not limited to transmitting, and verifying receipt of an operation. Providing may be accomplished via a wired or wireless network, a remote handled device in local communication, or any manner known or convenient.

Operation provider 104 may include hardware shared with head end server 102, or may include hardware separate from the head end 102. Operation provider 104 may include a processor coupled to a memory storing instructions to direct a processor to provide an operation. Operation provider 104 may include an authorization token request generator.

An operation may include, but is not limited to, transmitting data, implementing network layer security, installing, operating and/or maintaining, configuring, protecting a home network, configuring device keys, providing a device software and or a firmware update, or any known or convenient operation requiring security. An operation may originate, at the head end 102, the operation provider 104, or at the target device 106.

In a non-limiting example, the following could be operations: a device firmware could be upgraded, a device could be controlled, a 200-ampere switch (or other switch) could be enabled or disabled, a load could be limited to 50 amperes (or limited in other ways), a service could be delivered to a consumer, or the integrity of data collected could be determined.

In a non-limiting example, a target device 106 may have firmware, and the firmware may be modified or modifiable such as by being upgraded or upgradeable to a new version. In the example, the operation may begin at the head end 102 and be propagated out to the operation provider 104. The operation provider 104 may then provide the upgrade to the target device 106 along with an authorization token validating the upgrade. If the authorization token is missing or determined to be invalid, then the upgrade will not be permitted to take place such as by not accepting the upgraded firmware or by not executing the firmware upgrade for the upgrade file received.

In a non-limiting example, an operation directed to transmitting data may include data directed to reports and on-demand transactions that require or permit read only privileges. The head end 102 may have knowledge of the key associated with the operation and may decrypt the data received.

Target device 106 may include a radio capable of local and/or network communication, a wired connection, or any known or convenient device for communication. The head end 102 may include a key manager, and may or may not include the operation provider 104. The system 100 depicts items as separated, however, they may be combined or divided as is convenient, and may be connected by one or more networks.

In the example of FIG. 1, in operation, head end 102 provides an authorization token to operation provider 104. Operation provider 104 then provides the operation and the authorization token to the target device 106. Target device 106 performs the operation. The operation may be done either on or in cooperation with the operation provider 104 and with the head end 102.

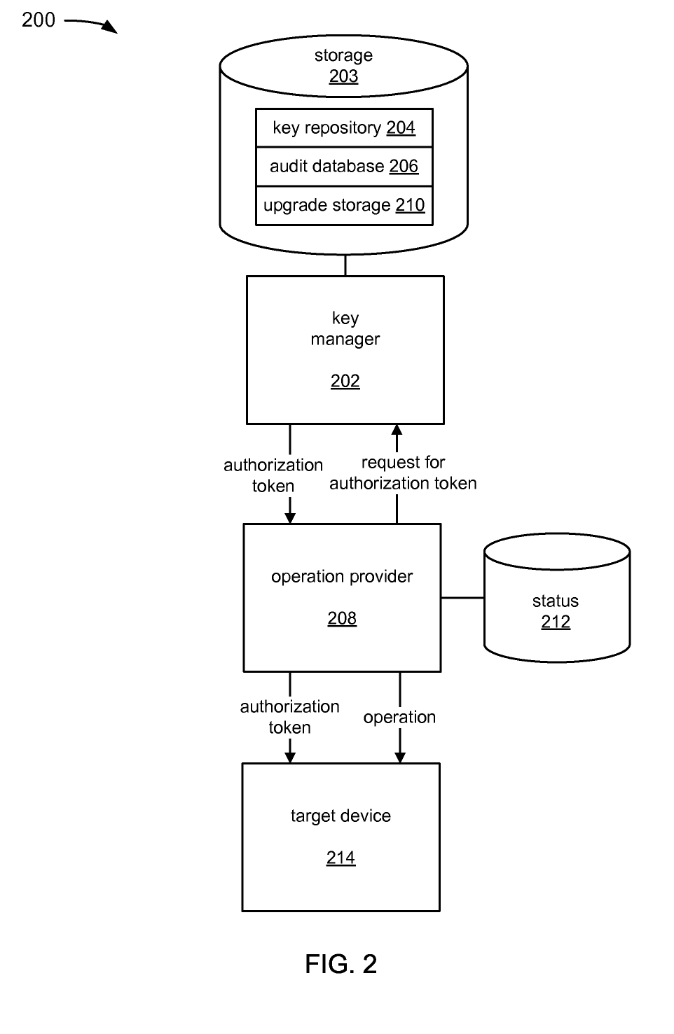

FIG. 2 depicts an exemplary system 200 for providing an authorization token. FIG. 2 includes key manager 202, key repository 204, audit database 206, operation provider 208, upgrades storage 210, status storage 212, and target device 214.

Key manager 202 may include a key generator, a protocol key access unit, a key exporter, a key importer, and a key upgrader.

The key repository 204 may be a database including one or more keys. As used herein, a database is intended to be interpreted broadly to include a traditional database, a data file, as well as any associated hardware and software. The key repository database 204 may be on a computing device coupled to a second computing device which includes the key manager 202.

The audit database 206 may be a log, a database, a data store, a file, or any known or convenient manner of storing events. The audit database 206 may include a requester, a time, an operation requested, and/or any other known or convenient data item. In a non-limiting example, a firmware upgrade operation may be performed, and the log may include an entry including the requestor (or target) of the firmware upgrade, the time the firmware upgrade was requested (or delivered), and the time the firmware upgrade was performed or completed.

The operation provider 208 may be a portable unit including hardware and software, a software component of a head end, or a computing device including hardware and software independent from the head end. The operation provider 208 includes instructions embodied in a computer readable medium, and functionality to communicate with a target device 214. In a non-limiting example, the communication functionality may include a radio.

The upgrades storage 210 may be a database, a data store, a file, or any known or convenient manner of storing upgrades or upgrade related data or information. The upgrades storage 210 may be stored on a non-volatile storage device coupled to, or included with, the key manager 202. Various different versions of upgrades may be included in the storage. Upgrades may be relevant to some operations, however, other operations may not involve updating and thus, may not require the upgrades storage 210.

The status storage 212 may be a database, a data store, a file, or any known or convenient manner of storing status. The status storage 212 may include entries associated with operations provided by operation provider 208.

The target device 214 may be or include a communications unit that includes a communications board, an in-home display unit, a thermostat, or any device requiring or benefiting from an operation. The target device 214 may have a radio, and may include a processor coupled to a memory storing instructions associated with one or more functions of the target device. The target device 214 may include more than one communications means such as a communication device or board, and may communicate on one or on more than one network.

In the example of FIG. 2, in operation, the operation provider 208 provides a request for an authorization token 220 to the key manager 202. The key manager 202 retrieves a key associated with the target device and generates an authorization token. The key manager 202 provides the authorization token 222 to the operation provider 208. The operation provider 208 provides the authorization token and the operation to the target device 214. The target device 214 may validate the operation using the authorization token and perform the operation.

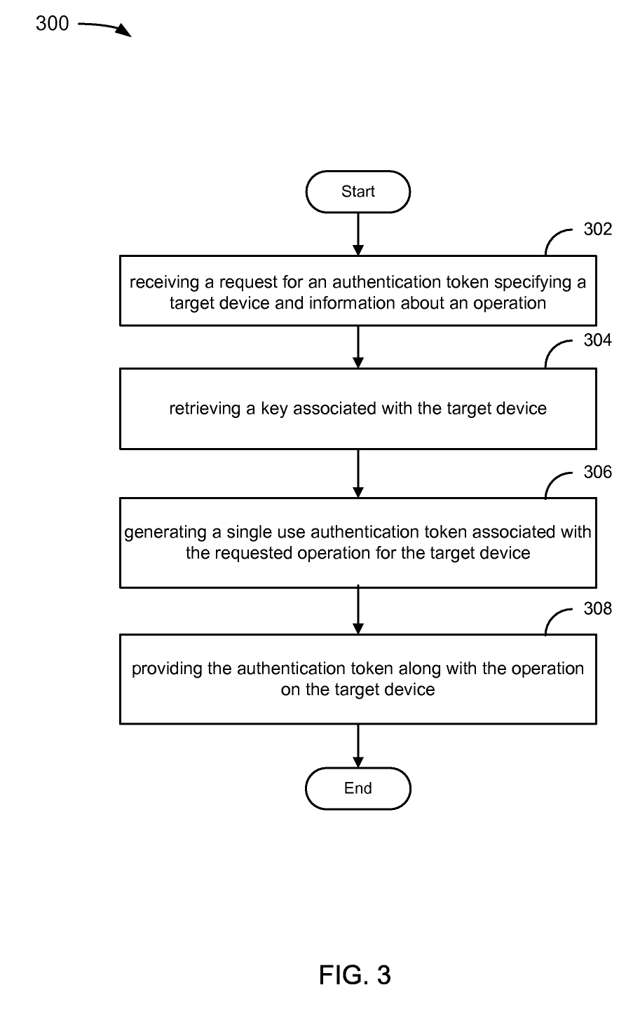

FIG. 3 depicts a flowchart of an exemplary method 300 for providing an authorization token. The method 300 is organized as a sequence of modules or steps in the flowchart. However, it should be understood that these and modules associated with other methods described herein may be reordered for parallel execution or into different sequences of modules.

In the example of FIG. 3, the method 300 starts at module or step 302 with receiving a request for an authorization token specifying a target device and information about an operation. The request may be generated by an operation provider, a head end, or a target device. The operation itself may be generated at the operation provider, the head end, or the target device.

In the example of FIG. 3, the method continues to module or step 304 with retrieving a key associated with the target device. The target device may have been associated with the key at the time of manufacture of the target device. The key may be stored in a key repository accessible to a key manager. The key repository may be included in a computer readable medium coupled to a processor executing instructions from a local memory.

In the example of FIG. 3, the method continues to module or step 306 with generating a single use authorization token associated with the requested operation for the target device. The operation requested may include information required to perform the upgrade, and include this information in the authorization token. In a non-limiting example, the operation is a firmware upgrade.

In the example of FIG. 3, the method continues to module or step 308 with providing the authorization token along with the operation to the target device. The operation may be transmitted or otherwise communicated to the target device. Wireless radio communications may be used. Alternatively, a wired connection to the target device may be used. Combinations of wired and wireless communications may also or alternatively be utilized.

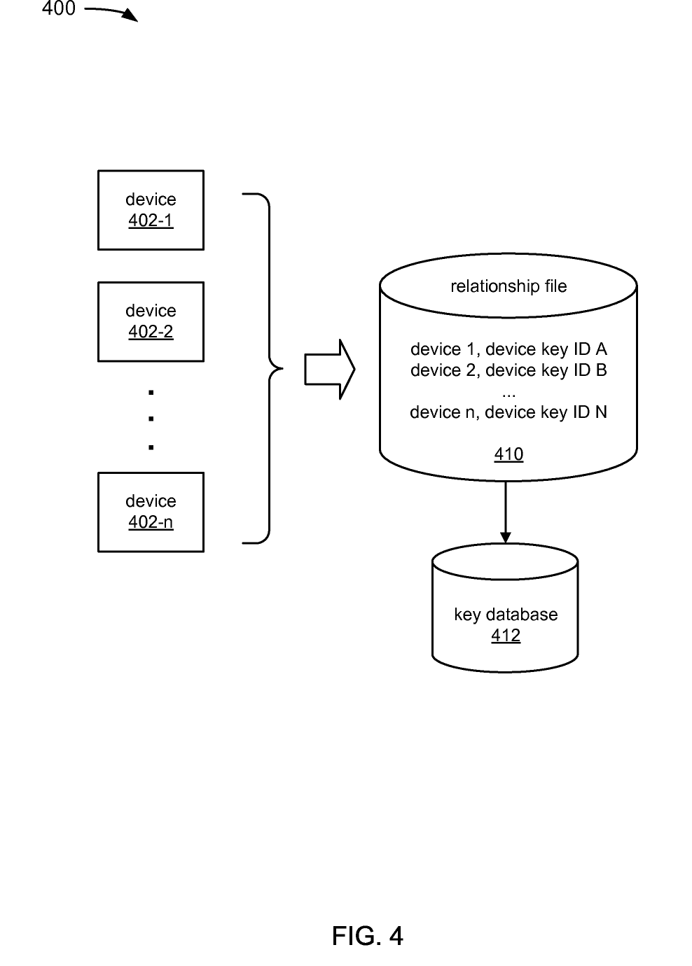

FIG. 4 depicts an exemplary system 400 including device keys entered into a key database. FIG. 4 includes device 402-1, device 402-2, and device 402-n (collectively devices 402) as well as relationship file 410, and key database 412. A device may have or more associated keys. The associated keys may be included in a relationship file indicating the relationship between the device and the key. The contents of the relationship file may be stored in the key database 412.

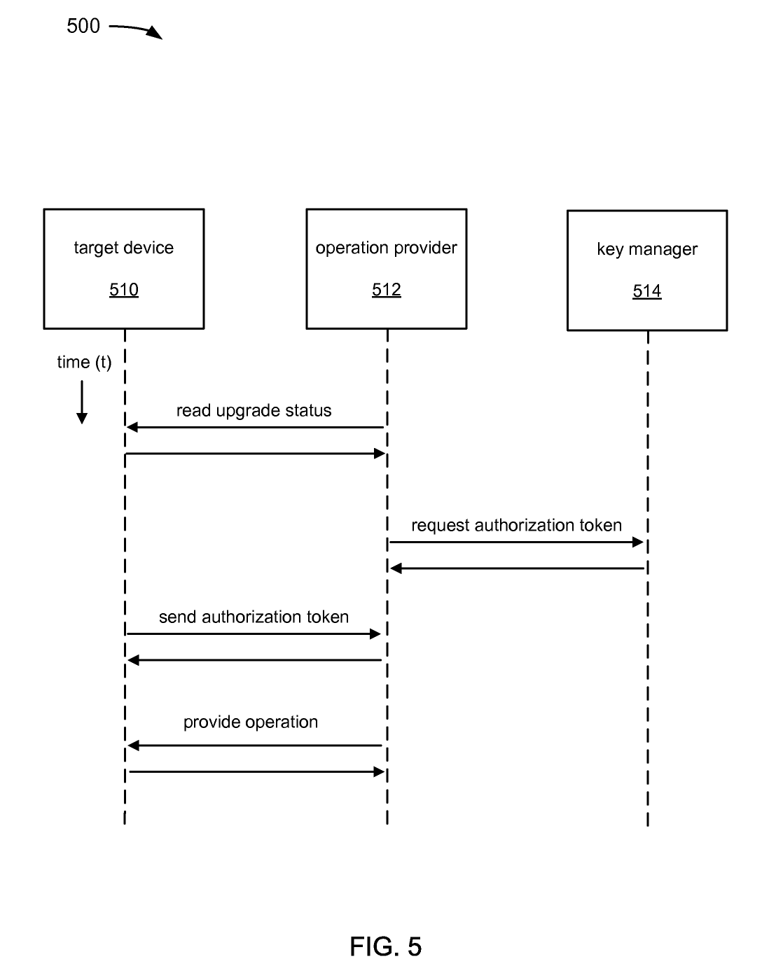

FIG. 5 depicts aspects of an exemplary method 500 for operation provider providing an operation to a target device using an authorization token. FIG. 5 includes target device 510, operation provider 512, and key repository 514. In the non-limiting example of FIG. 5, the operation may be a firmware upgrade or other operation. The operation provider may, for example, read the target device firmware version, download the status of the target device 510, request an authorization token from the key manager 514, authorize the operation with the target device 510, and provide the operation to target device 510. These steps are identified by the arrowed lines between the target device 510, operation provider 512, and key manager 514. Time is indicated by the arrowed “t.”

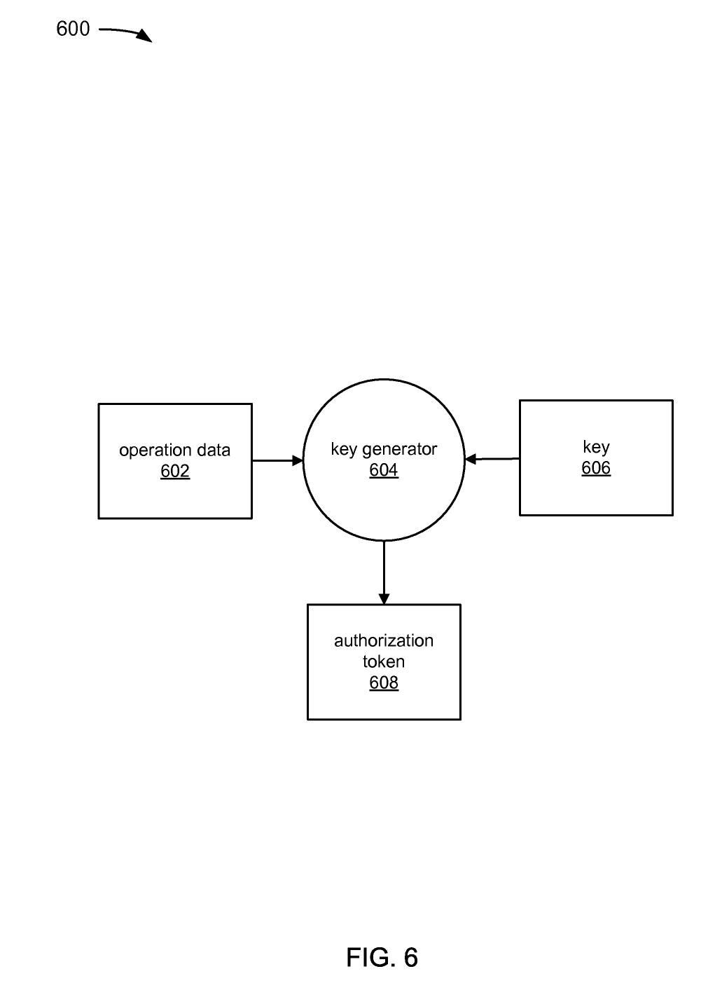

FIG. 6 depicts a diagram of an exemplary encryption module 600 creating an authorization token. FIG. 6 includes operation data 602, key generator 604, key 606, and authorization token 606.

The operation data 602 may include information associated with an individualized operation. In a non-limiting example, if the operation is a firmware upgrade or change, information may include allowed firmware, an old firmware version, a new firmware version, a firmware signature, a length or size of the new firmware, a device identifier or ID, a model and a data to validate the requester. The extent of the information is to assure that the upgrade is a compatible and appropriate upgrade and to prevent an upgrade that might disable the device. Any known or convenient data may be included.

The key generator 604 may include an encryption scheme. The key generator 604 may or may not be a part of the key manager. The encryption module may operate on the same hardware or different hardware from the key manager.

The key 606 may be a key from a key repository, such as the key repository 204 discussed in reference to FIG. 2. The key 606 may be associated with a target device, such as the target device 214 discussed in reference to FIG. 2. Such as a key may be created at the time of manufacture of the target device.

The authorization token 608 may include some or all of the operational data 602. The authorization token 608 may be encrypted using the key 606. The key 606 may be symmetric with another key, or may be asymmetric. Various key types are known in the art and may be used or adapted to the system and method.

In the example of FIG. 6, the key generator 604 encrypts the operational data 602 using the key 606 to produce an authorization token 608.

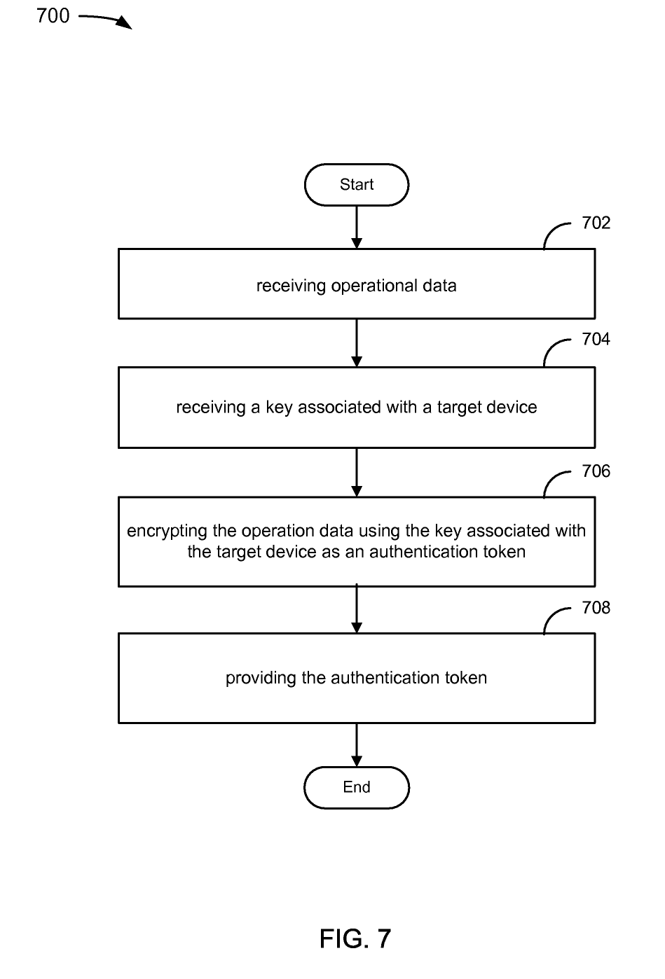

FIG. 7 depicts a flowchart of an exemplary method 700 for creating an authorization token. The method is organized as a sequence of modules in the flowchart. However, it should be understood that these and modules associated with other methods described herein may be reordered for parallel execution or into different sequences of modules.

In the example of FIG. 7, the method starts at module or step 702 with receiving operational data. The operation requested may include information required to perform the operation, such as to perform an upgrade operation. The information may be included in the authorization token. In a non-limiting example, the operation is a firmware upgrade. The allowed operation may include data associated with the operation. Information associated with a firmware upgrade may be included in the allowed operation.

In the example of FIG. 7, the method continues to module or step 704 with receiving a key associated with a target device. The key may be a key created at the time of manufacture of the device or otherwise created, and included in a key database associated with a key manager of a head end system.

In the example of FIG. 7, the method continues to module or step 706 with encrypting the operation data using the key associated with the target device as an authorization token. The encryption may be symmetric or asymmetric, but, for security, the encryption may advantageously only be decoded using the key of the target device using a key maintained by the target device. In a non-limiting example, the key is provided to the target device at the time of manufacture of the target device; all secure transmissions to the target device are encrypted by the sender for decryption using the key. The inability to decrypt may be interpreted by the device that the operation is not intended for the target device, and the target device may thus ignore the operation.

In the example of FIG. 7, the flowchart continues with providing the encrypted token. For security of the operation permitted by the authorization token, the authorization token is transmitted to the target device. The target device may decrypt the authorization token before the operation is performed to ensure that the operation is authorized for the target device.

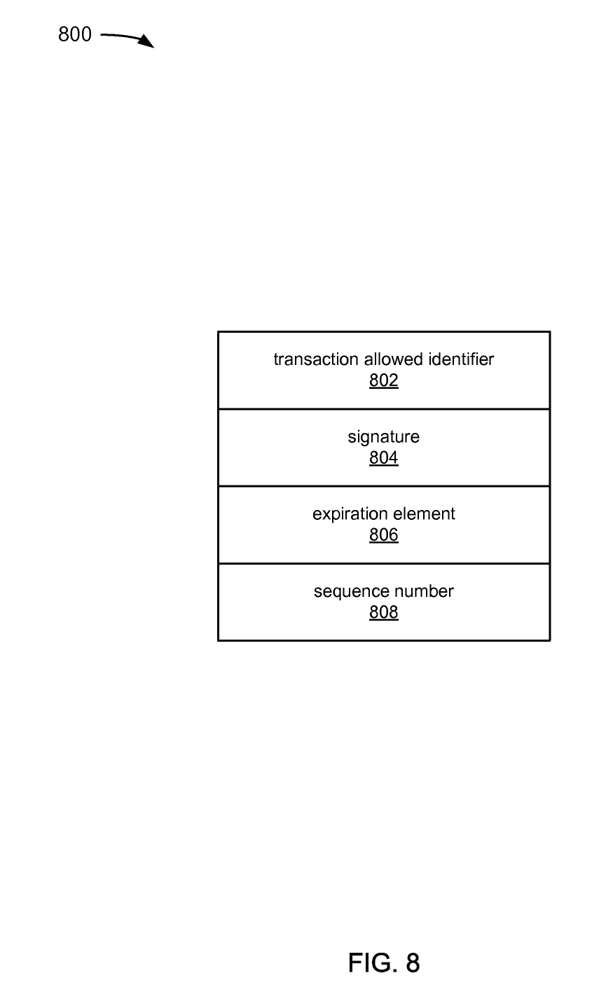

FIG. 8 depicts operation related data 800 which may be used to implement an authorization token. FIG. 8 includes a transaction allowed identifier 802, a signature 804, an expiration element 806, and a sequence number 808.

The transaction allowed identifier 802 may specify a permitted action associated with an operation. A target device may perform only an operation identified by the transaction allowed identifier 802.

The signature 804 validates the operation for the target device using a key of the target device.

The expiration element 806 may specify an amount of time that the authorization token is valid for or other expiration or validity information. In a non-limiting example, the time may be specified as a number of milliseconds, microseconds, or any amount of time known or convenient. An absolute expiration time and date may be alternatively specified. Providing an authorization token validity time period or expiration value is optional but advantageous for providing additional security.

The sequence number 808 may identify the authorization token. Where a head end system prepares and provides authorization tokens, the sequence number may identify an authorization token relative to other authorization tokens previously generated. The sequence number may be used to prevent the repeat use of an authorization token, such as to prevent a previously issued authorization token from being reused by a malicious party.

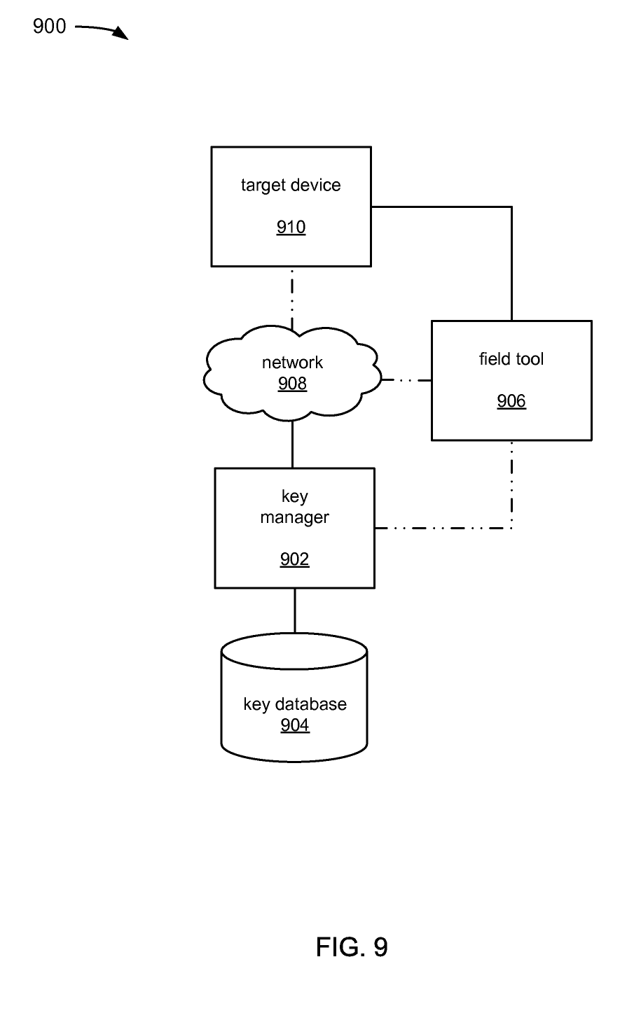

FIG. 9 depicts a diagram of a system 900 including remote tool using an authorization token to provide an operation to a remote target device having intermittent network communication. FIG. 9 includes a key manager 902, a key database 904, a field tool 906, a network 908, and a target device 910.

The key manager 902 may include an export module. The export module may include an encryption scheme to generate or provide an authorization token including one or more operation specific requirements. The key manager may be coupled to the key database 904.

The key database 904 may include a plurality of keys associated with devices. The key database 904 may be a file, a database, or any known or convenient manner of storing keys.

The field tool 906 may be a portable device. The field tool 906 may include a radio and a processor. The processor may be coupled to a memory including instructions which when executed causes the processor enter into local communication with a device. The field tool 906 may be capable of communication over a network and/or local communication.

The network 908 may be a wired or wireless network and may include wired and wireless segments. Data may be transmitted over the network 908. The network 908 may operate using the transport control protocol & internet protocol (TCP/IP), or alternatively the network 908 may operate the Trilliant Transport Protocol, or other known or convenient protocols.

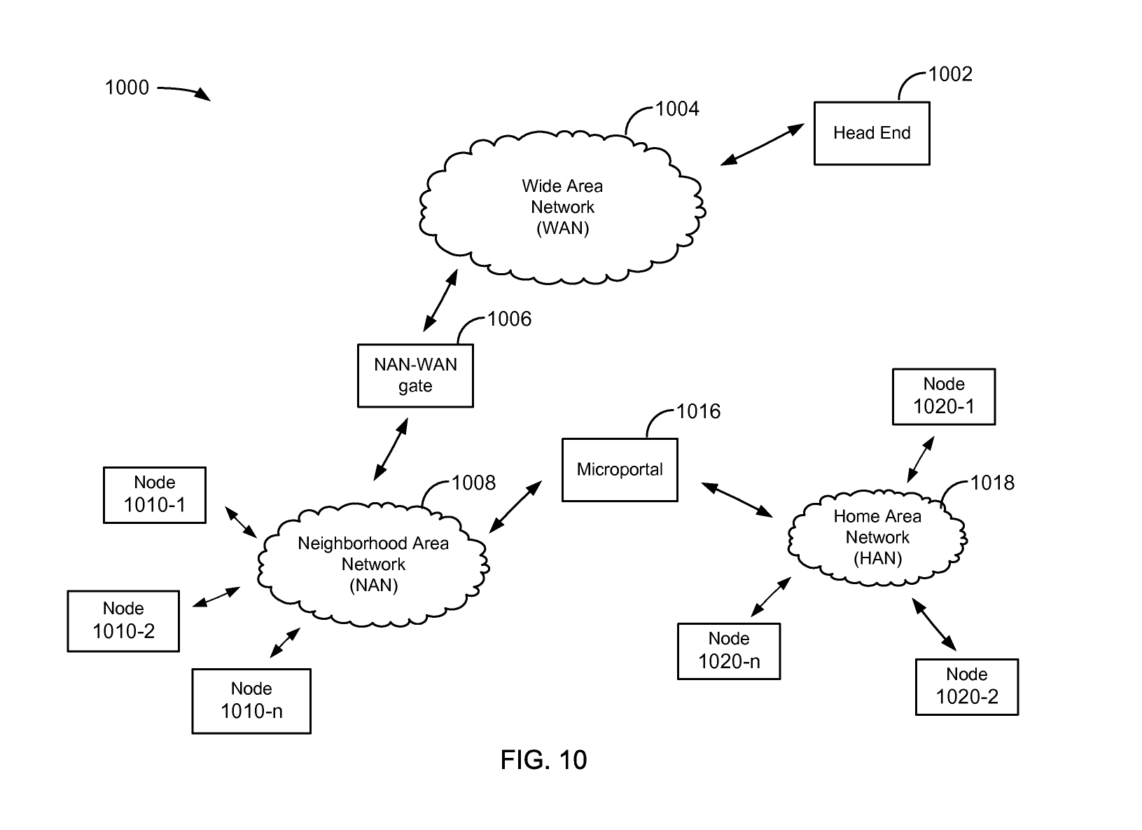

The target device 910 may include a radio and/or a wired network device. In a non-limiting example, the target device 910 is a communications unit of an electricity meter. The target device 910 could be one of the devices discussed in reference to FIG. 10.

In the example of FIG. 9, the key manager 902 prepares an authorization token and enters into either network or local communication with the field tool 906. The key manager 902 provides the authorization token to the field tool 906. The field tool 906 may disconnect from communication with the key manager 902. The field tool 906 may by physically transported to the local area of the target device 910. In the local area of the target device 910, the field tool 906 may enter into local communication with the target device 910, and may provide the authorization token to the target device 910. There the field tool 906 may provide the authorization token to the target device 910. An operation may be performed.

FIG. 10 depicts an exemplary configuration having a plurality of devices on an automated metering infrastructure (AMI) network 1000. FIG. 10 includes head end 1002, wide area network (WAN) 1004, NAN-WAN gate 1006, neighborhood area network (NAN) 1008, node 1010-1, node 1010-2, node 1010-n (collectively nodes 1010), microportal 1016, home area network (HAN) 1018 (sometimes referred to as a premise area network (PAN)), node 1020-1, node 1020-2, node 1020-n (collectively nodes 1020).

The head end 1002, sometimes referred to as the back end, server, or head end server can include a suite of applications including functionality for an acquisition system, real-time data access, device management, network management, and other known or convenient functionality. The head end 1002 can include one or more computing devices coupled or otherwise networked together.

The WAN 1004 can be, for example, metropolitan area network (MAN), global area network such as the Internet, any combination of such networks, or any other known convenient medium for communicating data. The WAN 1004 can include routers, switches and/or other networking hardware elements coupled together to provide communications to systems or within systems and devices coupled to the network 1004.

The NAN-WAN gate 1006, sometimes referred to as a mesh gate/collector, can include an IEEE 802.15.4 PAN Coordinator, an ANSI C12.22 Relay, a device collecting messages from multiple units on the NAN 1008 and a firewall. An IEEE 802.15.4 PAN Coordinator may be a device that is responsible for communication between devices on a NAN 1008 and complies with the IEEE 802.15.4 standard for transmission of data that is in effect as of the date of filing of this patent application. An ANSI C12.22 Relay may be a device that is responsible for communication between devices on a NAN and complies with the ANSI C12.22 standard for transmission of data that is in effect as of the date of filing of this patent application. An access point operable to perform many functions including for example, but not limited to, one or any combination of: relaying information from the head end server to the nodes, routing information, aggregating information from the nodes and micro portals within its sub-network for transmission to the head end server, acting as a HAN coordinator, transmitting mass firmware upgrades, and multicasting messages. A NAN-WAN gate 1006 may also be referred to as a collector because it collects information from the nodes 1010 and micro portal 1016 in its sub-network.

The NAN 1008, can be a wireless, wired, or mixed wireless and wired network. The NAN 1008 can transmit and receive signals using a protocol, for example, the IEEE 802.15.4 standard for transmission of data that is in effect as of the date of filing of this patent application can be used for wireless transmission. Similarly for wired transmission, the Ethernet/IEEE 802.3 interface standard could be used.

The nodes 1010 can be devices operable to collect metering information and transmit and receive signals via the NAN 1008 using any known or convenient protocol. Examples of nodes 1010 could be a meter, a thermostat, a remote appliance controller (RAC), in home display, or any known or convenient NAN device. Each of the nodes 1010 could potentially serve as a NAN-WAN gate 1006 by the addition of a WAN radio or wired device allowing communication over the WAN 1004.

The microportal 1016, sometimes referred to as a micro access portal or home gateway, may be a gateway in the sense that a protocol used by devices connected to the gateway use a different protocol than the gateway uses to connect to the nodes 1020. In a non-limiting example, ZigBee, Z-Wave, or X-4 may be used by the nodes 1020 to connect to the microportal 1016 whereas the microportal 1016 uses the Trilliant transport protocol to connect to the NAN-WAN gate 1008.

The HAN 1018 can be a wireless, wired, or mixed wireless and wired network. The NAN 1008 can transmit and receive signals using a protocol, by way of example and not limitation, the ZigBee, Z-Wave, or X-4 standard for transmission of data that is in effect as of the date of filing of this patent application can be used for wireless transmission. Similarly for wired transmission, the Ethernet/IEEE 802.3 interface standard could be used as well as other known or convenient wired interfaces.

The nodes 1020 can be devices operable to collect metering information and transmit and receive signals via the HAN 1018 using any known or convenient protocol. Examples of nodes 1020 could be a meter, a thermostat, a remote appliance controller (RAC), in home display, or any known or convenient NAN device. Each of the nodes 1010 could potentially serve as a microportal by the addition of a NAN radio or wired device allowing communication over the NAN 1004. Each of the nodes 1020 may include a radio and a processor coupled to a memory storing instructions. The nodes 1020, may each communicate using the ZigBee protocol, the Z-Wave protocol, X-10 or another known or convenient protocol.

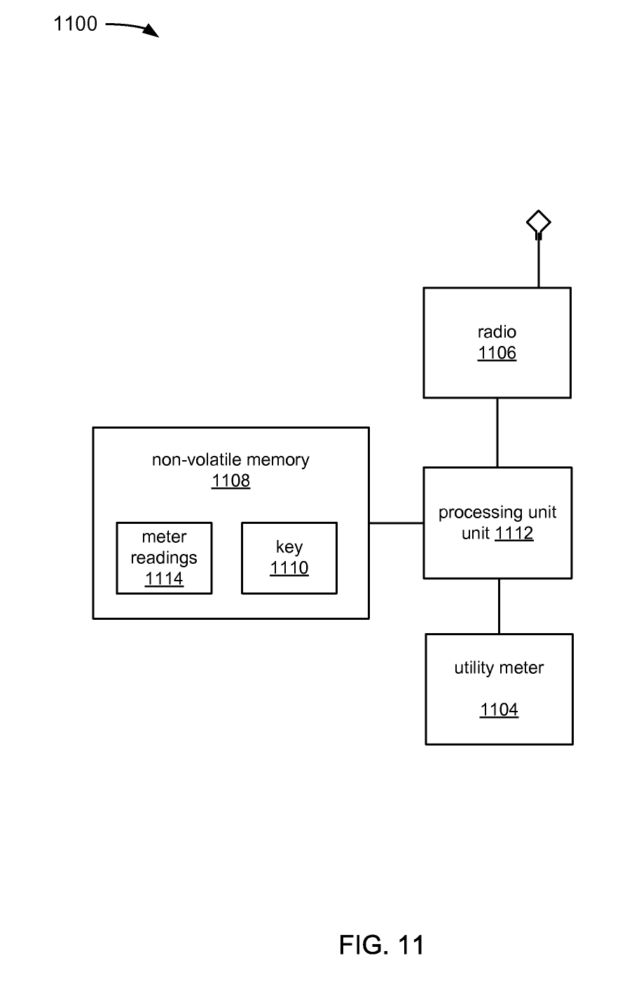

FIG. 11 depicts an exemplary target device 1102. FIG. 11 includes radio 1106, the non-volatile memory 1108, the processing unit 1112, and the utility meter 1104. The non-volatile memory 1108 includes key 1110. The utility meter 1104 may be an electricity meter. Processing unit 1112 may include communications logic as well as logic for storing meter readings from utility meter 1104 into non-volatile memory 1108. The non-volatile memory 1108 may include a key 1110 as well as meter readings 1114.

It will be appreciated to those skilled in the art that the preceding examples and embodiments are exemplary and not limiting in scope. It is intended that all permutations, enhancements, equivalents, and improvements thereto that are apparent to those skilled in the art upon a reading of the specification and a study of the drawings are included within the true spirit and scope of these teachings. It is therefore intended that the following appended claims include all such modifications, permutations, and equivalents as fall within the true spirit and scope of these teachings.

What is claimed is:

1. A system comprising:
a key repository for storing a key;
a key manager coupled to the key repository including a key generator for creating an authorization token using the key from the key repository; and
an operation provider in communication with the key manager which requests the authorization token from the key manager to provide security for an operation.

2. The system of claim 1, further comprising an audit database coupled to the key manager.

3. The system of claim 1, further comprising upgrades coupled to the operation provider.

4. The system of claim 3, wherein the upgrades comprise at least one of a software upgrade and a firmware upgrade.

5. The system of claim 1, further comprising status coupled to the operation provider.

6. The system of claim 1, wherein the key database includes an entry associating a key with a key identifier.

7. The system of claim 1, wherein the key manager includes a key generator; wherein, in operation, the key generator produces an authorization token.

8. The system of claim 1, further comprising a key stored in the key repository.

9. The system of claim 1, further comprising:
an audit database coupled to the key manager;
upgrades coupled to the operation provider, the upgrades comprise at least one of a software upgrade and a firmware upgrade;
status coupled to the operation provider;
the key database includes an entry associating a key with a key identifier;
the key manager includes a key generator, and in operation, the key generator produces an authorization token.

10. The system of claim 9, further comprising a key stored in the key repository.

11. A device comprising:
a nonvolatile storage for storing a key;
a radio receiving an authorization token and an operation; and
a logic unit coupled to the nonvolatile storage unit and the radio, wherein the logic unit receives the authorization token and the operation, decrypts the authorization token using the key, verifies the operation, and performs the operation.

12. The device of claim 11, further comprising the key stored in the nonvolatile storage.

13. A method comprising:
receiving a request for an authorization token specifying a target device;
retrieving a key associated with the target device;
generating a single use authorization token associated with an upgrade for the target device; and
providing the authorization token along with the upgrade to the target device.

14. The method of claim 13, wherein the target device is at least one of a radio, a communications card, a thermostat, and an electricity meter; and firmware of the target device is authorized for a secure upgrade by the authorization token.

15. The method of claim 13, wherein the target device controls power incoming into a building, and the target device may enable and disable the power incoming into the building.

16. The method of claim 13, wherein the target device is given a load limit.

17. A method comprising:
receiving an operational data;
receiving a key associated with a target device;
encrypting the allowed operation using the key associated with the target devices as an authorization token; and
providing the authorization token.

18. The method of claim 17, wherein the encryption is symmetric with a second key stored in the target device.

19. A data structure embodied in a computer readable medium comprising:
transaction-allowed identifier specifying a permitted action associated with an operation and a target device; and
a signature validating the operation for the target device using a key of the target device.

20. The data structure of claim 19, wherein the transaction-allowed identifier is associated with transmitting data, implementing network layer security, installing an application, or operation and maintenance, configuration modification, home network security, or device configuration.

21. The data structure of claim 19, further comprising an expiration element defining a time after which the target device will no longer accept the operation.

22. The data structure of claim 19, further comprising a sequence number identifying an upgrade as one operation of a series of operations of the target device, wherein, in operation, the target device will not accept the operation if the sequence number has been used before, or is lower than or equal to the sequence number of the most recent operation.

23. A system comprising:
means for storing a key;
means, coupled to the key storage, for generating an authorization token using the key; and
means for requesting the generated authorization to provide security for an operation.

24. A device comprising:
a nonvolatile storage means for storing a key;
a radio receiving an authorization token and an operation instruction; and
logic means coupled to the nonvolatile storage means and to the radio, wherein the logic means adapted to receive the authorization token and the operation instruction, to decrypts the authorization token using the key, to verify the operation instruction, and to perform the operation instruction.

25. A computer program stored in a computer readable form for execution in a processor and a processor coupled memory to implement a method comprising:
receiving a request for an authorization token specifying a target device;
retrieving a key associated with the target device;
generating a single use authorization token associated with an upgrade for the target device; and
providing the authorization token along with the upgrade to the target device.

26. A computer program stored in a computer readable form for execution in a processor and a processor coupled memory to implement a method comprising:
receiving an operational data;
receiving a key associated with a target device;
encrypting the allowed operation using the key associated with the target devices as an authorization token; and
providing the authorization token.
